(19) United States
(12) Patent Application Publication
(10) Pub. No.: US 2004/0088226 A1
(43) Pub. Date: May 6, 2004

(54) Method of conducting auction by switching modes

(76) Inventors: Woo-Chan Cho, Seoul (KR); So-Yong Baek, Seoul (KR)

Correspondence Address: Pennie & Edmonds, 1155 Avenue of the Americas, New York, NY, 10036-2711, US

(21) Appl. No.: 10/473,266

(22) PCT Filed: Mar. 26, 2002
(86) PCT No.: PCT/KR02/00525

(30) Foreign Application Priority Data
Mar. 26, 2001 (KR) 10-2001-0015775

(51) Int. Cl. G06F 17/60

(52) U.S. Cl. 705/26

(57) ABSTRACT

A method of conducting for transaction between a seller and a purchaser through a computer by automatically switching the auction from a bulletin mode into a chatting mode includes the steps of inputting registration information of an article for sale from a seller and then outputting schematically the registration information on information window to the purchaser; inputting bids for the article to the computer selected from the information window; calculating the beginning of the chatting mode in accordance with initiating factor for the article based on the bids and then outputting to activating the chatting mode for the article; and completing the action for the article and then selecting a successful bidder for the article.

### TECHNICAL FIELD

The present invention relates to the electronic commerce for realizing transaction between sellers and buyers, and more particularly to an auction method for realizing transaction between sellers and buyers through a computer system which automatically switches the auction from a bulletin board mode into a chatting mode.

### BACKGROUND ART

The development of computer networks activates the electronic commerce which realizes transaction between sellers and buyers through exchange of electronic documents. Particularly, the auction-type transaction manner is recently rising in popularity.

The on-line auction is briefly classified into a general auction, a reverse auction and a joint purchasing. The on-line auction can be also conducted in a bulletin board mode and a chatting mode.

Such a conventional on-line auction is progressed as follows. In brief, sellers register articles on sale to an auction agent. In this case, the sellers access an auction server of the auction to register the articles on sale. Information of the articles on sale is stored in a database of the auction server. After that, if a buyer requests the information of an article, the auction server searches the database and then provides the corresponding information.

In the auction method using the bulletin board mode, a buyer accesses the auction server to search a desired article. Then, the auction server provides information about the articles on sale to the buyer, and the buyer selects an article for bids based on the information. After that, the buyer registers a bidding price for the selected article to the auction server. Through the above processes, the auction server receives bidding prices from buyers who want to purchase the article. If the auction is concluded, the auction server determines a successful bidder based on the bidding prices stored in the database.

In the auction method using the chatting mode, a buyer firstly accesses the auction server to search articles for bids, similarly to the bulletin board mode. Then, the auction server provides an initiating time of the chatting mode together with information about the articles on sale. Based on the provided information, the buyer selects a desired article like the bulletin board mode. Since the auction server provides only the information of the article together with the initiating time of the chatting mode, the buyer cannot put in a bid until the initiating time of the chatting mode. On the while, if the initiating time of the chatting mode is up, the auction server opens a chatting room so that buyers may put in a bid. Thus, the buyers can propose a bidding price(s) only while the chatting room is established, and the auction is progressed in real time.

However, the auction method using the bulletin board mode has a disadvantage that bidding prices are not proposed in real time if many buyers bid prices at a time close to an auction conclusion, for example 5 minutes the auction conclusion. A web page provided from the auction server to a buyer just contains the auction information at the moment the user requests the web page. Thus, auction information after the moment cannot be provided through that web page. In order to obtain auction information after that moment, the buyer should receive the auction information again from the auction server by generally clicking the reload button on a web browser. In brief, in the auction method using the bulletin board mode, the buyers not only cannot receive the auction information in real time, but also cannot be aware who is a competitor, who has abandoned, what price is bid and so on.

In addition, the auction method using the chatting mode also has shortcoming that buyers can participate in the auction in a limited time that the chatting room is open since the auction should be conducted through real-time chatting. Moreover, the buyer who wants to participate in the auction cannot put in a bid if the buyer does not access the auction server within the limited time.

### DISCLOSURE OF INVENTION

The present invention is designed to overcome the above problems of the prior art, and an object of the invention is to provide a method of conducting an auction firstly in a bulletin board mode and then switching the bulletin board mode into a chatting mode.

In addition, another object of the present invention is to provide a method of conducting an auction in which a seller or a manager of the auction can set the switching time of the auction mode in advance.

In order to accomplish the above object, the present invention provides a method of conducting an auction between sellers and buyers through a computer by switching modes, which includes the steps of receiving registration information of articles on sale from the sellers and displaying the registration information on an information window of the computer to output the registration information to the buyers; inputting a bidding request for a selected article from the information window into the computer; calculating an initiating time of a chatting mode for the article on basis of a predetermined initiating condition when there is a bid for the article and then activating and outputting the chatting mode for the article at the initiating time; and selecting a successful bidder for the article when the chatting mode for the article is concluded.

In another aspect of the present invention, there is also provided a method of conducting an auction between sellers and buyers through a computer by switching modes, which includes the steps of receiving registration information of articles on sale from the sellers and displaying the registration information on an information window of the computer to output the registration information to the buyers; inputting a bidding request for a selected article from the information window into the computer; calculating an initiating time of a chatting mode for the article on basis of a predetermined initiating condition according to a predetermined checking cycle and then activating and outputting the chatting mode for the article at the initiating time; and selecting a successful bidder for the article when the auction for the article is concluded.

Preferably, the chatting mode activating and outputting step activates the chatting mode after the bulletin board mode is completed.

In addition, the bulletin board activating and outputting step may calculate a residual time until the chatting mode on basis of the initiating condition and then display the residual time on a bulletin board.

In addition, the chatting mode activating and outputting mode may output auction history generated in the bulletin board mode together with the registration information on a display window of the chatting mode.

In addition, the registration information of the article on sale preferably includes a desired contract price, and the auction may be concluded according to the desired contract price.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing a network system in which an auction method of the present invention is executed;

FIG. 2 is a functional block diagram showing an auction server configured according to an embodiment of the present invention;

FIG. 3 is a flow chart for illustrating the process of registering an article on sale by a seller according to an embodiment of the present invention;

FIG. 4 is a flow chart for illustrating the auction process executed in an embodiment of the present invention;

FIG. 5 exemplarily shows a web page on which an article on sale can be registered and searched;

FIG. 6 exemplarily shows a web page for registering an article on sale;

FIG. 7 exemplarily shows a web page containing a sub-category of the articles on sale;

FIG. 8 exemplarily shows a web page containing detailed information of an article on sale;

FIG. 9 exemplarily shows a web page in which a bulletin board mode is activated;

FIG. 10 exemplarily shows a web page in which a chatting mode is activated; and

FIG. 11 is a flow chart for illustrating the process of conducting an auction according to another embodiment of the present invention.

### BEST MODES FOR CARRYING OUT THE INVENTION

Hereinafter, preferred embodiments of the present invention will be described in detail with reference to the accompanying drawings.

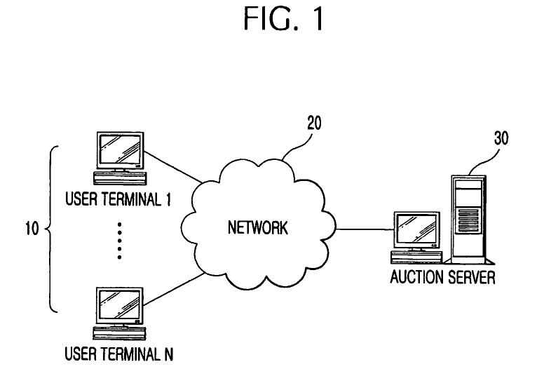

FIG. 1 schematically shows a network system to realize an auction method operated by multiple modes, which car be automatically switched, according to an embodiment of the present invention.

The network system includes a plurality of user terminals 10, an auction server 30 and a network 20 for interconnection thereof.

The user terminal 10 is a client system used for a user, who can be a seller or a buyer, to access the auction server 30 through the network 20 and then register an article on sale or put in a bid. The user terminal 10 can be a personal computer having a data communication function, a cellular phone, PCS, a wireless communication terminal such as PDA and an IMT-2000 terminal.

The user terminal 10 is a computer of a client who can be a seller registering an article on sale to the auction server 30 or a buyer bidding a price for the registered article. While the user terminal of a seller is a terminal possessed by a seller who sells a specific article in case of a general auction, the user terminal of a seller can also be a terminal possessed by a buyer who wants to purchase a specific article in case of a reverse auction. Similarly, while the user terminal of a buyer is a terminal possessed by a buyer who wants to purchase a specific article in case of a general auction, the user terminal of a buyer can also be a terminal possessed by a seller who sells a specific article in case of a reverse auction.

The auction server 30 is a computer system which allows a seller to register an article on sale and a buyer to put in a bid for the registered article. Particularly, the auction server 30 has a function of automatically switching the bulletin board mode of the auction into the real-time chatting mode at a specific point of time.

The network 20 allows the user terminals 20 and the auction server 30 to be connected in common for mutual data communication, and can be a wire/wireless Internet, PSTN (Public Switched Telephone Network), a mobile communication network and so on.

In the following description, it is set that the network 20 is a wire Internet based on the World Wide Web (WWW) and the user terminal 10 is a personal computer, as a representative example. However, the present invention is not limited to those cases of course.

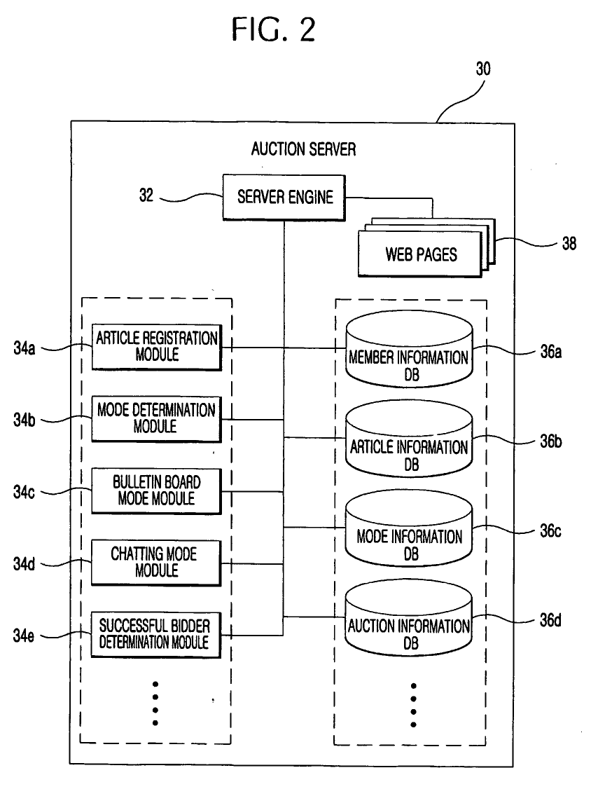

FIG. 2 shows a functional configuration of the auction server 30 according to the present invention.

The auction server 30 includes a server engine 32, a plurality of web pages 38, an article registration module 34a, a mode determination module 34b, a bulletin board mode module 34c, a chatting mode module 34d, a successful bidder determination module 34e, a member information DB 36a, an article information DB 36b, a mode information DB 36c, an auction information DB 36a and so on.

The server engine 32 provides various web pages 38 to the accessed user terminal 10 and also provides the platform for server-side programs such as the above functional modules 34a-34e. In addition, when a user registers as a member, the server engine 32 stores input information to the member information DB 36a.

At this time, the web pages 38 are preferably made in HTML format, but the web pages 38 can be written in any format capable of being read out by a computer system.

The article registration module 34a presents an article registration document to a terminal of a seller who wants to register an article on sale. The article registration module 34a also extracts article information from the article registration document written by the seller and then stores and manages the article information in the article information DB 36b. The article information includes personal information, a title of the auction, a name of the article, an amount of the article, a desired contract price, a lowest bidding price, selection of the chatting mode, an initiating condition of the chatting mode, an auction progressing manner and so on.

The “desired contract price” is a desired price for transaction of the article proposed by the seller. If a price equal to or higher than the desired contract price is bid, the auction is concluded and a bidder of that price is selected as a successful bidder.

The mode determination module 34b determines a point of time to switch the current bulletin board mode into the real-time chatting mode periodically or when an event such as a request of bidding from a buyer occurs. If determining that the point of time for initiating the chatting mode, the mode determination module 34b automatically switches the auction into the chatting mode. However, if the mode determination module 34b determines that it is time to progress the bulletin board mode, the mode determination module 34b instructs the bulletin board module 34c to progress the bulletin board mode. Or, if the initiating time of the chatting mode is up and the initiating condition of the chatting mode is satisfied, the mode determination module 34b instructs the chatting mode module 34d to open a chatting room and progress the chatting mode. Particularly, in order to instruct opening and progressing of the chatting mode, the mode determination module 34b transmits auction information, article information and recent bidding information, which may include a current highest price bidder, a current highest bidding price, a title of the auction, a conclusion time of the auction, a name of the article, a residual time till the auction conclusion and so on, to the chatting mode module 34d.

The bulletin board module 34c extracts article information of a specific article from the article information DB 36b on request of a buyer and then provides the article information to the buyer on a web document. Thus, the buyer can put in a bid for the article by registering a bidding price in the web document.

The chatting mode module 34d receiving the instruction of executing the chatting mode from the mode determination module 34b opens a chatting room for the corresponding article on basis of the auction information, the article information and the recent bidding information, and then progresses a real-time auction through the established chatting room.

The successful bidder determination module 34e determines the buyer who bids a price equal to or higher than the desired contract price proposed by the seller as a successful bidder and then concludes the auction. The successful bidder determination module 34e also provides a current highest bidding price to buyers so that the buyers may bid only a price higher than the current highest bidding price. Thus, a final bidder is a buyer who bids a highest price up to the moment. Similarly, the final bidder is the most probable successful bidder. After the auction is concluded, the final bidder is determined as a successful bidder, and the results such as a successful bidder, a contract price and a contacted amount are stored in the auction information ID 36d.

Though the article registration module, the mode determination module, the bulletin board mode module, the chatting module and the successful bidder determination module are shown and illustrated in the drawings and description as separate independent hardware, this shows only functional classification based on their roles, and the person skilled in the art may understand that the terms of the article registration module, the mode determination module, the bulletin board mode module, the chatting module and the successful bidder determination module are used as meanings including reaction between application programs and the hardware.

On the other hand, the auction server 30 is operated in linkage with various databases, which basically include the member information DB 36a, the article information DB 36b, the mode information DB 36c and the auction information DB 36d.

The member information DB 36a stores a member name, ID corresponding to the member name, a password, an address, a resident registration number and a price settlement manner. For example, the price settlement manner includes a credit card number and a serial number of a deposit account having an automatic money transfer function, which can be used for settlement of the price.

The article information DB 36b stores, for each article, the article registration information such as personal information of a seller, a title of the auction, a name of the article, an amount of the article, a desired contract price, a lowest bidding price, selection of the chatting mode, an initiating condition of the chatting mode, an auction executing manner, a picture of the article, a point of time for the auction conclusion and so on.

The mode information DB 36c stores an initiating condition set by a seller for a corresponding article, selection of the chatting mode, a point of the auction conclusion time and so on for each article. The mode information DB 36c also stores information informing buyers whether the chatting room is open or not.

The auction information DB 36d stores bidders, a bidding price of each bidder, a bidding amount of each bidder and so on, for each article. Among the bidders a bidder who proposes a highest bidding price becomes a most probable successful bidder. Thus, the current highest bidding price and the bidder proposing the current highest bidding price are stored in the auction information DB 36d as a highest price bidder, and other buyers can participate in the auction only by bidding a price higher than the current highest bidding price. Thus, a buyer who finally participates in the auction becomes a candidate of a successful bidder, and the information about the candidate is also stored in the auction information DB 36d. When the chatting mode is activated, this information about the candidate is transmitted to the chatting mode. After the auction is concluded, the information about the auction such as a successful bidder, a contract price, a contract amount of the article and an auction concluded time is stored in the auction information DB 36d for each article.

The Process of Registering an Article on sale by a Seller

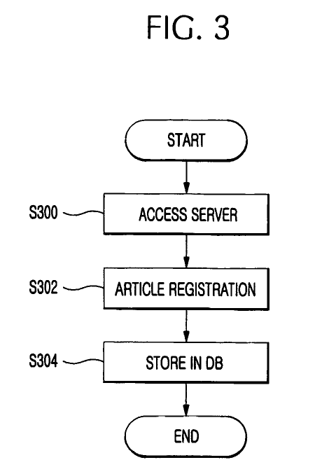

FIG. 3 is a flow chart for illustrating the process of registering an article on sale to the auction server by a seller.

Referring to FIG. 3, a seller accesses an auction site on Internet by using a computer with a communication tool such as a web browser S300. In this case, the auction site is represented by a specific URL, and the seller accesses the URL by using a web browser.

The auction server 30 transmits a web page corresponding to the URL to the seller, and the web browser interprets the corresponding web page by code analysis and then displays the web page so that the seller may read the web page.

The auction server 30 may firstly request the seller to register for usage of its service. The seller registers agreement on the proposed provisions and then registers identification information such as ID, password, name, contact number and address. The auction server 30 then receives the usage registration of the corresponding seller through a predetermined checking procedure. The information input for the usage registration is all stored in the member information DB 36a.

The auction server 30 may request the registered seller to log in and the seller logs in the server by inputting the requested ID and password.

The usage registration and logging-in are a very generalized web site accessing procedure, which is preferably, but not essentially, adopted. In some cases, the seller may use the auction service according to the present invention without the usage registration and logging-in procedure.

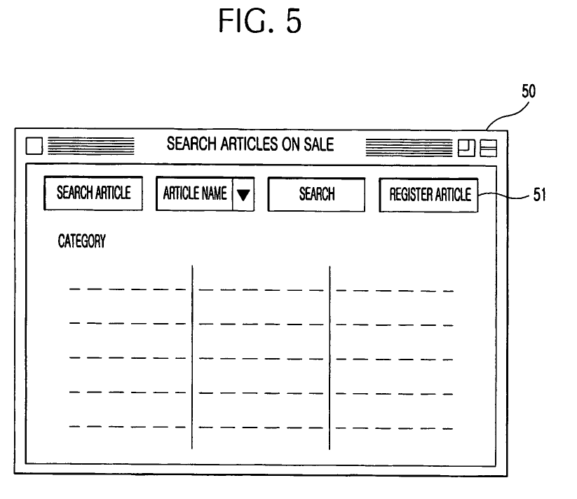

The server engine 32 then provides a main web page (see FIG. 5) to a logged-in seller so that the seller may be provided with information about currently auctioned articles and various service menus. The seller may check and select the information and the service menus in the main web page.

As well known in the art, the web page of FIG. 5 is provided with hyperlinks for connection to other web pages. Thus, the main web page may give connection to a plurality of subordinate web pages according to selection of the user.

In order to register an article on sale by auction, the seller clicks an article registration button 51 shown in FIG. 5. At the same time, the article registration module 34a shows an article registration window 60, which is a document for article registration, to the seller. The seller then inputs and registers information about the article on sale in the article registration window 60 S302. The proposed input window includes input sections for personal information of the seller, a title of the auction, a name of the article, an amount of the article, a desired contract price, a lowest bidding price, selection of the chatting mode, an initiating condition of the chatting mode, an auction executing manner, a picture of the article, a point of time for the auction conclusion and so on, and the seller inputs the above information in the corresponding sections.

When the article on sale is registered, the auction server can arbitrarily set a period of the chatting mode, for example 2 hours before the auction conclusion.

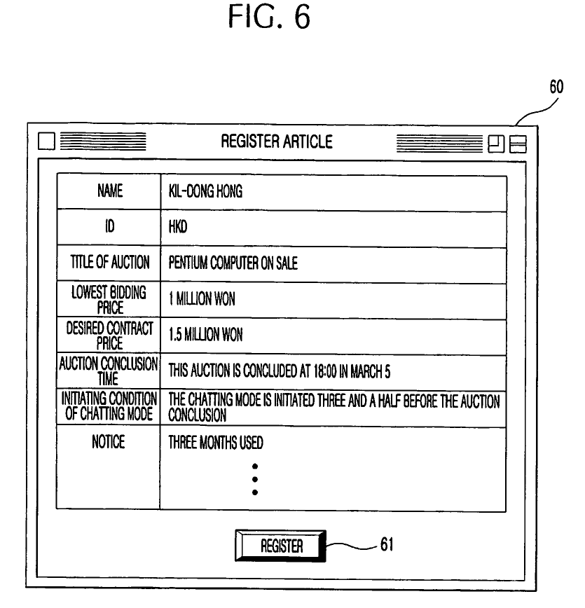

More preferably, when the article on sale is registered, the seller may set the initiating condition of the chatting mode as he/she desires. For example, as shown in the web page of FIG. 6, the seller may input the initiating condition of the chatting mode as “the chatting mode will be initiated three and a half hours before the auction conclusion”.

In provision for the case that the seller not wanting to progress the chatting mode, a selection icon informing of “the chatting mode is not wanted. Can be provided in the web page of FIG. 6. Thus, the seller may determine whether or not to progress the chatting mode.

If the information about the article on sale is all input, the seller clicks a ‘register’ button 61. Then, the article registration module 34a stores the input article information in the article information DB 36b for each article S304.

The Process of Putting in a Bid by a Buyer

First Embodiment

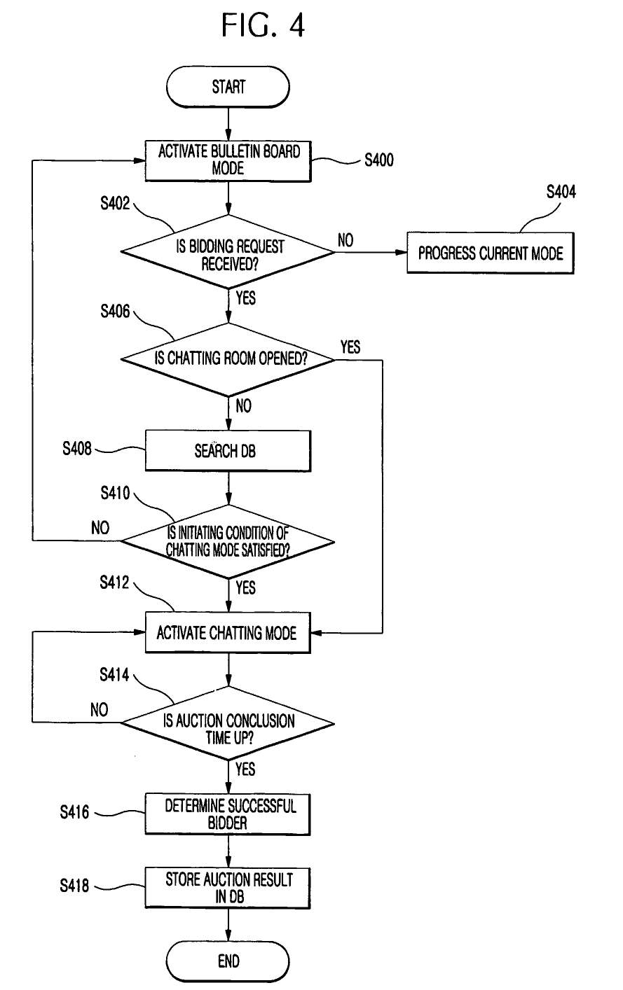

Referring to FIGS. 4 to 10, the method of conducting an auction on line through multiple modes which can be switched according to the present invention will be described in detail.

First, FIG. 4 is a flow chart for illustrating the process of progressing the auction executed by the auction server.

The procedure for a buyer to access the auction server 30 is identical to the case of the seller. The server engine 32 similarly provides a web page 50 of FIG. 5 to the buyer so that the logged-in buyer may be provided with information about currently auctioned articles and various service menus. The buyer may check and select the information and the service menus in the web page 50.

In order to search the information about the articles on sale, the buyer directly inputs a name of a desired article on the web page of FIG. 5 or uses a subsequent article category with hyperlinks.

If the buyer requests information of a specific article, the bulletin board module 34c searches the article information DB 36b and then provides the corresponding article information to the buyer.

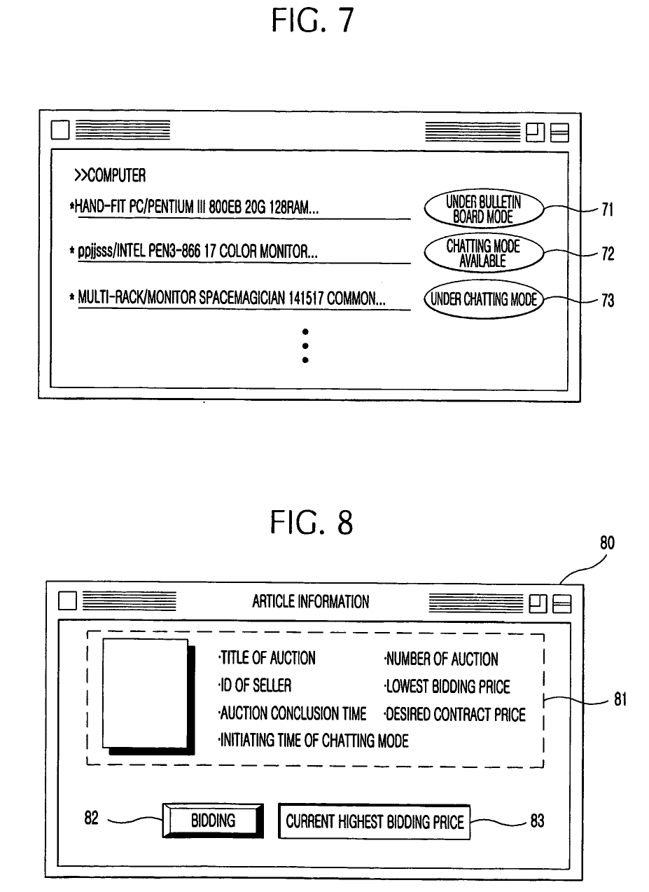

Searched results and subordinate categories of the article are well shown in the web page of FIG. 7, as an example.

The buyer clicks a desired one among auction titles notified in the web page of FIG. 7. Then, the bulletin board mode module 34c searches the article information DB 36b o provide information about the corresponding article to the buyer through an article information window 80 shown in FIG. 8, and at this time the bulletin board mode is activated S400.

Referring to FIG. 8, the article information window 80 which the bulletin board mode module 34c searches in the article information DB 36b and the provides contains an information section 81, a ‘bidding’ button 82 and a ‘current highest bidding price’ section 83. The information section 81 also includes information such as personal information of a seller, a title of the auction, an amount of the article, a desired contract price, a lowest bidding price, selection of the chatting mode, an initiating condition of the chatting mode, an auction progressing manner, a picture of the article and an auction conclusion time. Thus, the buyer may be provided with detailed information through the article information window 80.

The buyer may notify a possible bidding price at that instant through the price displayed on the ‘current highest bidding price’ section 83. The buyer may put in a bid just by proposing a price higher than the current highest bidding price.

In other words, when the buyer wants to purchase the article by proposing a price higher than the current highest bidding price, the buyer clicks the ‘bidding’ button 82 shown in FIG. 8 to put in a bid. Then, the mode determination module 34d receives the bidding request S402, and then searches the mode information DB 36c. The mode determination module 34b then determines whether or not to open a chatting room on basis of analysis of data stored in the mode information DB 36c S406.

If the chatting room is opened in the step S406, the mode determination module 34b instructs the chatting mode module 34d to progress the chatting mode. Then, the chatting mode module 34d shows a previously established chatting room 110 to the buyer. Then, the chatting mode is activated and progressed for the buyer S412.

Preferably, an indication “under chatting mode” 73 can be displayed in addition to the name of the article so that the buyer may more easily recognize that the chatting mode is in progress, as shown in FIG. 7. This indication 73 can be also preferably blinked or moved so that the buyer may recognize a current mode at a glance.

If a bidding request is not received from the buyer in the step S402, the mode determination module 34b does not give any action, and the auction keeps its current mode S404.

If the chatting room is determined not to be opened in the step S406, the mode determination module 34b searches the mode information DB 36c S408 and then analyzes an initiating condition of the chatting mode stored in the mode information DB 36c to determine whether the initiating condition of the chatting mode is satisfied S410.

Preferably, the initiating condition of the chatting mode can be data indicating a point of time that the chatting mode starts.

If the initiating condition of the chatting mode is not satisfied in the step S410, the mode determination module 34b instructs the bulletin board mode module 34c to progress the bulletin board mode. Then, the bulletin board mode module 34c provides a bulletin board mode window 90 to the buyer, and thus the bulletin board mode is activated and progressed S400.

Preferably, an indication “under bulletin board mode” 71 can be displayed in addition to the name of the article as shown in FIG. 7 so that the buyer may more easily recognize that the bulletin board mode is activated. This indication 71 can be also preferably blinked or moved so that the buyer may recognize a current mode at a glance.

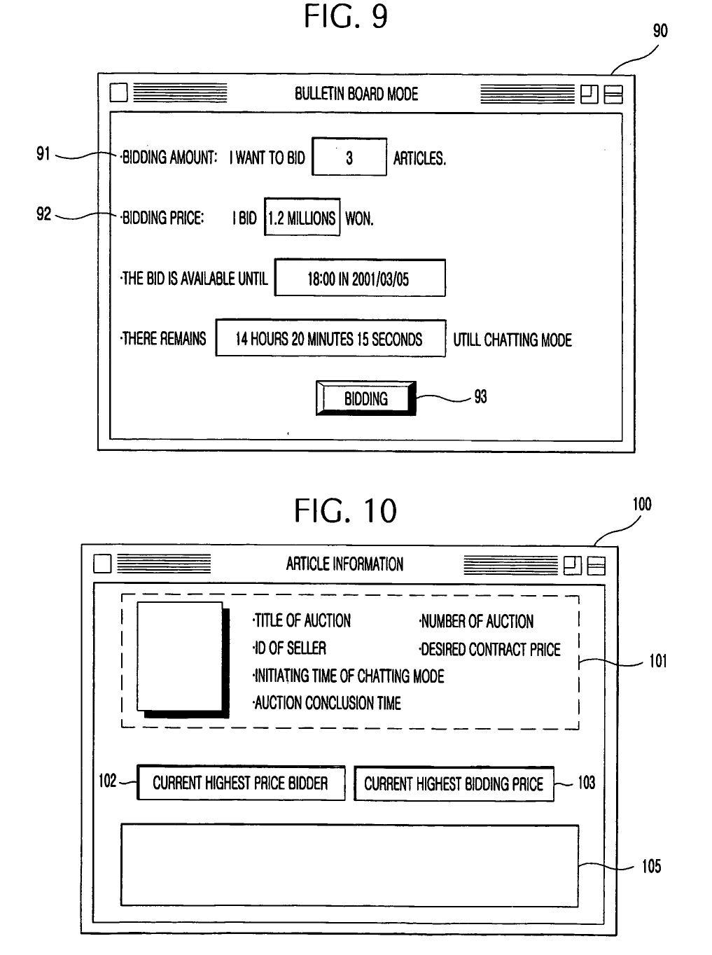

The bulletin board mode window 90 of FIG. 9 provides an input section 91 for inputting an amount of the article and an input section 92 for inputting a bidding price. If the buyer inputs the amount and the bidding price and then clicks a ‘bidding’ button 93, the input information is transmitted through the bulletin board mode module 34c so as to be stored and registered in the auction information DB 36d.

Preferably, the bulletin board mode window 90 may display an auction conclusion time and a residual time until activation of the chatting mode to the buyer, as shown in FIG. 9.

More preferably, the successful bidder determination module 34e may compare the bidding price registered by the buyer with the desired contract price proposed by the seller with use of data stored in the auction information DB 36d and the auction information DB 36d. If the bidding price is equal to or higher than the desired contract price, the bidder is determined as a successful bidder S416. Then, the auction result is stored in the auction information DB 36d S418, and then the auction is concluded.

On the other hand, if the initiating condition of the chatting mode is satisfied in the step S410, the mode determination module 34b instructs the chatting mode module 34d to open a chatting room and progress the chatting mode. Then, the chatting mode module 34d provides a chatting mode window 110 to the buyer with opening the chatting room, and then the chatting mode is activated and progressed S412.

Preferably, an indication “chatting mode available” 72 can be displayed in addition to the name of the article so that the buyer may more easily recognize that the chatting mode can be activated, as shown in FIG. 7. This indication 72 can be also preferably blinked or moved so that the buyer may recognize a current mode at a glance.

The chatting mode module 34d searches information such as a current highest bidding price and a highest price bidder from the article information DB 36b and the auction information DB 36d before activating the chatting mode. At this time, a chatting mode window 100 includes an article section 101, a “current highest price bidder”section 102 and a “highest bidding price” section together with a conversation section 105 to be displayed to the buyer, as shown in FIG. 10. The article section 101 contains the personal information of the seller, the title of auction, the name of article, the amount of article, the desired contract price, the initiating condition of the chatting mode, the auction progressing manner, the picture of article, the auction conclusion time and so on. This information is searched from the article information DB 36b and the auction information DB 36d by the chatting mode module 34d and then provided to the buyer. In this chatting mode, the buyer is also capable of putting in a bid just by proposing a bidding price higher than the current highest bidding price, identically to the step S400. The buyer then puts in a bid through the conversation section 115 as the chatting mode is progressed. The bidding price proposed by the buyer is stored in the auction information DB 36d by the chatting mode module 34d.

Preferably, it is also possible that a buyer who proposes a bidding price equal to or higher than the desired contract price is determined as a successful bidder and then the auction is concluded, similar to the bulletin board mode.

After the step S412, the mode determination module 34b searches the mode information DB 36c to determine whether the auction conclusion time is up S414. If it is determined that the auction conclusion time is up in the step S414, the chatting mode module 34d finishes the chatting mode.

After the auction is concluded, the successful bidder determination module 34e determines a buyer who puts in a final bidder in the bulletin mode or the chatting mode as a successful bidder on basis of the data stored in the auction information DB 36d since the buyer proposes a highest bidding price S416. Then, the auction results such as a successful bidder, a contract price and a contract amount are stored in the auction information DB 36d S418. Then, all processes are completed.

On the other hand, if the auction conclusion time is not up in the step S414, the chatting mode module 34d provides the chatting mode to the buyer until the auction conclusion time.

Second Embodiment

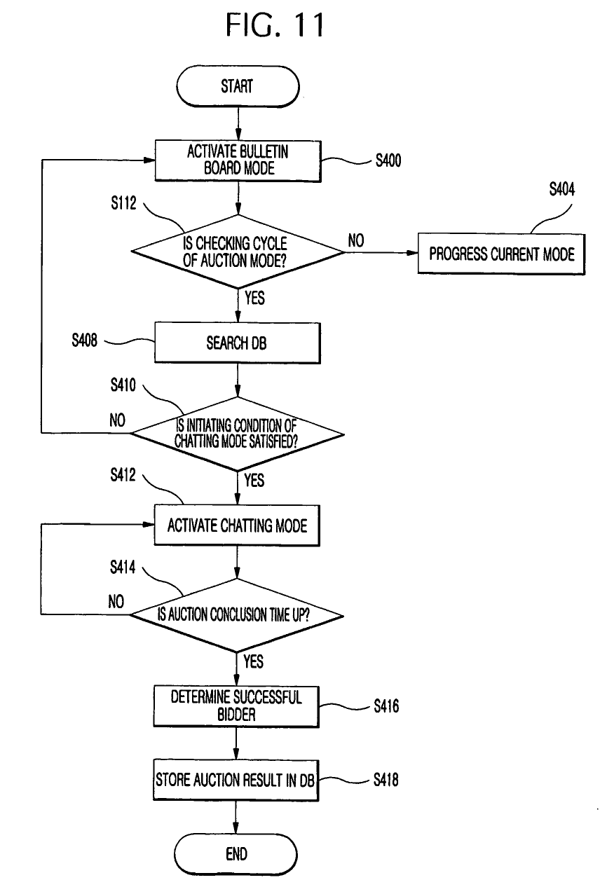

The auction server 30 may progress an auction in a different way to the first embodiment. The auction progressing manner of this embodiment is substantially identical to that of the first embodiment except the process of determining the auction mode, which is described below in detail with reference to FIG. 11.

In this embodiment, the mode determination module 34b has a predetermined checking cycle for the auction mode. For example, the checking cycle is set to have an interval of 3 or 5 minutes.

After the bulletin board mode is activated in the step S400, the mode determination module 34b determines whether or not the auction mode checking cycle comes S112.

If the checking cycle does not come in the step S112, the auction is progressed with the current auction mode S404.

However, if it is determined that the checking cycle comes in the step S112, the mode determination module 34b searches the node information DB 36c S408 and then analyzes an initiating condition of the chatting mode on basis of the data stored in the mode information DB 36c to determine whether the initiating condition of the chatting mode is satisfied S410.

If the initiating condition of the chatting mode is satisfied in the step S410, the process is forwarded to the step S412.

Or, if the initiating condition of the chatting mode is not satisfied in the step S410, the process is forwarded to the step S400.

Other processes S412 to S418 except the above description of this embodiment are identical to the first embodiment. After the processes, the auction is concluded.

The Auction Progressing Manner of Buyer Depending on Mode State

First Embodiment

TABLE 1

| Mode State | Auction progressing manner of a buyer |
|---|---|
| Under the bulletin | The bulletin board mode is progressed in the |
| board mode, and an | step S400. |
| initiating condition of | |
| the chatting mode is | |
| not satisfied. | |
| Switching from the | The bulletin board mode is progressed in the |
| bulletin board mode to | step S400, the chatting mode is progressed |
| the chatting mode | through the steps S402, S406, S408, S410 |
| | and S412, and then the auction is progressed |
| | through the steps S414, S416 and S418. |
| Under the chatting | The chatting mode is progressed through the |
| mode and the chatting | steps S402, S406 and S412, and then the |
| room is opened | auction is progressed through the S414, S416 |
| | and S418. |
| Under the chatting | The chatting mode is progressed through the |
| mode but the chatting | S402, S404, S408, S410 and S412, and then |
| room is not yet opened | the auction is progressed through the S414, |
| | S416 and S418. |

The table 1 shows various cases to conduct an auction in the first embodiment at the side of a buyer who accesses the auction server for participating in the auction. The auction is conducted in different ways depending on a mode state of the auction server. As shown in the table 1, there are four cases for a buyer to conduct an auction, and the auction is progressed according to the corresponding orders in each case. The corresponding steps are identical to the above description.

Second Embodiment

TABLE 2

| Mode State | Auction progressing manner of a buyer |
|---|---|
| Under the bulletin | The bulletin board mode is progressed in the |
| board mode, and an | step S400. |
| initiating condition of | |
| the chatting mode is | |
| not satisfied. | |
| Switching from the | The bulletin board mode is progressed in the |
| bulletin board mode to | step S400, the chatting mode is progressed |
| the chatting mode | through the steps S112, S408, S410 and |
| | S412, and then the auction is progressed |
| | through the steps S414, S416 and S418. |
| Under the chatting | The chatting mode is progressed through the |
| mode | step S412, and then the auction is progressed |
| | through the S414, S416 and S418. |

The table 2 shows various cases to conduct an auction in the second embodiment at the side of a buyer who accesses the auction server for participating in the auction. As shown in the table 2, there are three cases for a buyer to conduct an auction, and the auction is progressed according to the corresponding orders in each case. The corresponding steps are identical to the above description.

INDUSTRIAL APPLICABILITY

The auction method of the present invention described above is operated with multiple modes and these modes can be automatically switched. In addition, a seller may set a point of time to switch the modes as desires.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. (amended) a method of conducting an auction between sellers and buyers through a computer by switching modes, comprising the steps of:
(a) receiving registration information of articles on sale including a bidding price and an auction period required for the auction from the sellers and register the registration information in a database of the computer;
(b) displaying brief information of the registered articles on a bulletin board-type information window with reference to the database so that the brief information is publicly notified to a plurality of buyers;
(c) receiving a bidding request for the article selected in the information window from the buyers, and determining time of a chatting mode auction for the article on the basis of a predetermined initiating condition when there is a bidding request;
(d) activating and proceeding one of a bulletin board mode auction and the chatting mode auction for the article on the basis of the determination.

2. (amended) A method of conducting an auction according to claim 1, before the step (c), further comprising the step of
the computer checking the initiating condition of each article on sale according to a predetermined period, and then activating the chatting mode auction when the initiating tine of the chatting mode auction is up.

3. A method of conducting an auction according to claim 1,
wherein the registration information of an article includes a desired contract price of the article, and the auction is concluded when the desired contract price is bid.

4. (amended) A method of conducting an auction according to claim 1, wherein, the information window displays a current auction mode of each article on sale.

5. (amended) A method of conducting an auction according to claim 1,
wherein, in the step (d), when it is before the initiating time of the chatting mode auction, a bulletin board mode auction is activated for Q the article.

6. (amended) A method of conducting an auction according to claim 5,
wherein the step (d) keeps the auction for the article by activating the chatting mode auction after the bulletin board mode auction is

7. (amended) A method of conducting an auction according to claim 1,
wherein the initiating condition is set by a manager of the computer.

8. (amended) A method of conducting an auction according
wherein, in the step (a), the computer further receives the initiating condition for determining the initiating time of the chatting mode auction from the seller.

9. (amended) A method of conducting an auction according to claim 5,
wherein a web page outputting the activated bulletin board mode auction displays a residual time until the chatting mode auction is C) activated.

10. (cancelled)

11. (cancelled)

12. (cancelled)

13. (cancelled)

14. (cancelled)

15. (cancelled)

16. (cancelled)

17. (cancelled)

18. (cancelled)

19. (cancelled)
